(19) United States
(12) Patent Application Publication
(10) Pub. No.: US 2008/0087160 A1
(43) Pub. Date: Apr. 17, 2008

(54) Method and apparatus for teaching music and for recognizing chords and intervals

(76) Inventor: David E. Gabert, (US)

Correspondence Address: BURLESON COOKE L.L.P., 2040 NORTH LOOP 336 WEST, SUITE 123, CONROE, TX, 77304, US

(21) Appl. No.: 11/949,694

(22) Filed: Dec. 3, 2007

Related U.S. Application Data
(63) Continuation-in-part of application No. 11/266,613, filed on Nov. 3, 2005.
(60) Provisional application No. 60/626,093, filed on Nov. 8, 2004.

(51) Int. Cl. G09B 15/08; G09B 15/02

(52) U.S. Cl. 84/478; 84/483.2

(57) ABSTRACT

A method for teaching musical theory wherein each note of the chromatic scale is associated with one of three markings, preferably incorporating three distinct colors, making a repeating pattern up and down the musical scale. The preferred colors are silver, black, and gold. Some instruments are adapted to use with the system by marking playing positions on the instrument, such as keys or fingering positions, according to the marking system. Sheet music may also be adapted to embodiments of the method by indicating notes in the color associated with that note. Note recognition and musical theory, including chord structures, are taught using patterns of colors corresponding to different notes, chords, musical keys, etc.

This application is a Continuation-in-Part of U.S. patent application Ser. No. 11/266,613, filed Nov. 8, 2005, which claims the benefit of U.S. Provisional Application No. 60/626,093 filed on Nov. 8, 2004, both of which are incorporated herein by reference in their entirety.

### BACKGROUND OF THE INVENTION

1. Field of the Invention

The present disclosure relates to methods and apparatus for the study, teaching, learning, and reinforcement of musical theory and the composition and performance of music, particularly with instruments. More particularly, it relates to a method and apparatus for visually displaying different chord structures through color patterns on written musical annotations and on musical instruments.

2. Description of Related Art

Using traditional methods, music students typically spend several years struggling to learn the theory behind western music. This lack of understanding can retard progression, development, and endurance as a musician, particularly for piano and guitar. Musicians also must learn various chords (i.e., specific groups of notes) and Major or minor scales (twelve of each) having seven notes each that can often seem rather cryptic or arbitrary to the novice. The only possible exception is the C Major scale, which consists of the seven naturals—i.e., the ivory keys on the piano, but even there the seven consecutive white keys give no actual guidance to musical theory (all other major scales use a combination of ebony and ivory keys).

The study of musical theory is an essential part of any correctly designed instructional program. For example, the study of music theory is required of all NASM accredited universities and colleges in the U.S. The disclosed system is designed to augment and facilitate rather than replace these formal studies. It may be illustrated directly on the musical instrument, allowing the learner more time with their instrument and eliminating many frequent book review sessions.

The daunting task of learning music theory and perfecting performance has historically approached in a rather ad hoc fashion with little regard for generally accepted music theory, except for the most studied pedagogue or highly trained musician. As a result, most musicians play predominantly in only a handful of Keys. Many more aspiring musicians give up, sometimes after years of practice, never realizing how simple it can be to learn and play music. Consequently, music remains a mystery to most people, including some with musical experience, for whom it is still like a dark, Black Forest with few known paths, patterns, guides, or directions for the lost.

Part of the problem is the inherent complexity of the ongoing task of organizing the traditional twelve-note chromatic scale (i.e., the twelve notes in any octave range of notes) consisting of seven “natural” denominated with the letters A through G and five “flats” (i.e., Ab, Bb, Db, Eb, and Gb) or “sharps” (G#, A#, C#, D#, and F#), which is mostly easily seen in relation to a piano keyboard where the naturals correspond to ivory keys and the flats or sharps correspond to ebony keys. For convenience and to avoid confusion, references to the names of notes will be capitalized and italicized (e.g., Ab).

This system of notation is mostly a matter of deliberate design, with a heavy dose of historical accident thrown in, and is the predominant system in the world and is the only system of note used in this country. Although this system generates a recognizable pattern of keys on a piano-style keyboard, even the learned ability to quickly recognize which key corresponds to which note does not provide great assistance in learning chords or scales, which are numerous and still must be memorized.

Because of the foregoing obstacles, all but the most advanced musicians play almost exclusively in only a handful of Keys and struggle to leave that comfort zone. Although it is possible to play any song in any key, no matter in which it was written, the mental gymnastics required to read the music, determine the adjustment, and then play the correct note—all occurring in an instant—can be overwhelming and discouraging. Rote memorization and practice can alleviate some of this, but is often too daunting or requires too much time for the amateur musician.

Attempts have been made to simplify note recognition and to aid novice musicians to locate the proper key, fret, finger position, etc. For example, MacCutcheon (U.S. Pat. No. 6,870,085) discloses a system with seven color-symbol combinations for each of the natural notes (i.e., ivory keys on the piano). The same color-symbol combination is used for related flats or sharps (i.e., adjacent ebony keys on the piano), which results in two different color-symbol combinations for each of these notes (i.e., one each for the sharp and flat).

Pertchik (U.S. Pat. No. 6,566,593) teaches a modified keyboard with an equal number of keys in each of two registers (as opposed to the conventional ratio of seven ivory keys to five ebony keys on the upper and lower registers on a standard keyboard). Adjacent keys in a register are two half-steps apart. The key that represents the note between those adjacent keys is located approximately between them on the other register. The keys are colored (or otherwise marked) with three colors in repeating fashion on consecutive notes. Pertchik teaches that his keyboard helps with note recognition and with learning scales, but does disclose any means or method for teaching chord structure or progression using his keyboard.

Mead (U.S. Pat. No. 6,483,018) teaches a fingerboard map for unfretted string instruments. The map uses different shapes for naturals versus flats and sharps, but does not use any markings to identify notes. Similarly, Coonce (U.S. Pat. No. 6,452,080) also discloses a system for identifying finger positions on an unfretted string instrument. Colors are used to identify the finger position for specific notes.

Bennett (U.S. Pat. No. 6,288,315) discloses an apparatus that attempts to indicate various notes, chords, and scales. The user must properly place a movable template over the fingerboard or keyboard. More than one template appears to be required to practice the invention, particularly for keyboard instruments. Seven colors are used to indicate natural notes, with a combination of two colors used to indicate flats and sharps, but as with other seven marker systems, Bennett does not truly simplify learning. Rather, one system of note recognition is simply substituted for another, both using unique markings to identify each note.

None of these systems disclose a generally applicable and simplified method for recognizing notes and chords or for illustrating visually the structure of western musical theory. Thus, there is a need for a simple method for teaching quick recognition of notes and chords and for locating the ubiquitous nearby chord structure from any position.

### SUMMARY OF INVENTION

A method for teaching musical theory and recognition of chords and chord structure is disclosed. The notes of the chromatic scale are associated with three repeating markings. Different chords are readily recognizable as each type of chord has a unique pattern of Markings. In a preferred embodiment, the marking comprise three distinct colors, and may comprise other characteristics related to shape and/or touch (i.e., surfaces identifiable by touch alone).

### BRIEF DESCRIPTION OF THE DRAWINGS

FIG. 1 is a view one embodiment of the disclosed method applied to a section of a standard keyboard.

FIG. 2 is a view of another embodiment of the disclosed method applied to the neck of a six-string guitar with fourteen frets illustrated, configured for a right-handed musician. The top of FIG. 2 corresponds to the end of the neck (where lower notes are fretted) and the bottom of FIG. 2 corresponds to the base of the neck (where higher notes are fretted).

FIG. 3 is the Circle of Fifths adapted to the disclosed method by applying the color pattern to the Keys in the Circle. The Circle of Fifths is also sometimes referred to as the Circle of Fourths and the two titles as used herein refer to the same thing.

### DETAILED DESCRIPTION

The disclosed method or system provides a simple, visually and/or tactilely recognizable system for organizing the mystique of music into the familiar sounds we love and desire to hear. Since these sounds and harmonies are generally constructed of chords or chord tones, the disclosed system presents a simple, permanent visual and/or tactile markings which separates the seemingly random notes into three sets of recognizable categories (i.e., the three diminished 7^{th} chords). The system is said to be “permanent” because it is the same no matter what type of chord is being played or in which Key the music is written. It is also permanent in the sense that it does not need to be modified or adjusted to teach different chords, Keys, etc. It is a final and holistic approach, revealing the shifting nature of the relationships of these three sets of color or diminished chords.

The disclosed method, notation, and apparatus share a common element, the organization of the twelve-notes in an octave into sets of three notes associated with a pattern of three distinctive markings repeating four times per octave. The disclosed system with its three marking scheme instantly reveals to the eye and/or fingers the location of all traditional Major, minor, or other chord tones from the perspective of a given tonic in all twelve keys simultaneously, and identifies simple patterns for the simple shifting of tonal center or selection of proper or improvised note, depending on which category of Tonic, Chord Tone, or Off Tone marking applies. With the disclosed system applied to a keyboard, the meaning of the keyboard or piano is staring back at the player in the forms and structures that are natural to music, but have never been illustrated thereon. The marking scheme simply illustrates to the eye or touch the aspects of general music theory, as it reflects the structure of simple chord progressions, complex intervals, cadences, and more. This is particularly true for the guitar, where all chord progressions, especially the I, IV, I, V, I and the ii, V, and I, which together are probably the most common chords in the blues or in jazz and rock and roll music, with many subtle variations available. Furthermore, the disclosed system assists in locating and handling local chord progressions, which tend to cluster together.

The chosen markings should be easily distinguished one from another. Preferably, this is accomplished at least in part by associating three distinct colors with the three markings. Alternatively, distinct shapes may also be used. In embodiments for the visually impaired, the markings should have surfaces with distinctly different feels to the touch. These embodiments may also be preferred for those who are not visually impaired as they facilitate note identification with touch without moving the back and forth between sheet music and instruments. Tactilely identifiable embodiments for the visually impaired are still preferably also distinguishable by shape and/or color as most instructors are not visually impaired and will be able to monitor their student using such embodiments. The preferred embodiment uses distinctive colors and such embodiments will be used in the exemplary embodiments herein, but the invention is not limited to embodiments that use distinctive colors and, in effect, eliminates “counting” intervals, long the bane of many pianists.

Standard musical terminology is generally used throughout this disclosure to avoid confusion and because no attempt is made herein to introduce a new theory of chords, scales, etc. The purpose and intent of the system is to augment the teaching of current musical concepts rather than displace them. Indeed, the effect of the disclosed system is to help teachers and learners master and apply current musical theory more fluently and efficiently.

As used herein, the term “instrument” refers to anything that can be used to generate musical notes, including the human voice. The term applies equally whether the instrument is capable of producing only one note or multiple notes simultaneously. It follows that the term “musician,” as used herein, includes a singer or vocalist.

As used herein, the term “keyboard” usually refers to any instrument using a standard piano-type arrangement of keys that are depressed to cause notes to be played. However, other arrangements of keys have been disclosed and are within the scope of the term, especially as used in the claims, and the disclosed system will work equally well no matter how the keys are arranged, so long as it is compatible with a sequential chromatic scale. Any number of such keys may constitute a keyboard. Examples of keyboards include acoustic and electric pianos or keyboards, organs, harpsichords, and accordions. Because the traditional piano-type arrangement of keys is found on virtually all keyboards, the disclosed system will be illustrated and discussed in connection with these keyboards, but is not limited thereto. To avoid confusion, piano keys will be referred to herein as ivory and ebony rather than black and white. Also, the term “key” refers to a single key on a keyboard (e.g., the ivory key corresponding to B) while “Key” refers to the Key in which music is written (e.g., F minor or C Major). To avoid confusion, the names of specific notes and chords are italicized (e.g., A minor scale versus a minor scale, the former being a specific scale and the latter being a generic reference to any minor scale).

As used herein, the term “string instrument” refers to any instrument played by causing strings to vibrate, including instruments typically played by striking or strumming the strings (e.g., a guitar) or with a bow (e.g., a violin). The tone of a string on a string instrument is typically controlled by pressing a finger onto the string to change the length of the string that vibrates. The correct position for a finger to play the desired note is referred to herein as a “finger position” and the term applies equally to instruments with or without frets as the disclosed system is fully compatible with fretted and unfretted string instruments. The term “fingerboard” is used to reference the part of any string instrument where a musician presses a string to select a given note or tone and applies equally to string instruments with or without frets. A “finger position” is the p roper place to press a string to play a given note.

As used herein, the term “guitar” refers to guitar-type instruments with any number or arrangement of strings. Thus, it includes both the ubiquitous six-string guitar most commonly associated with the term and the four-string bass guitar. Because of its greater use and appeal, the common six-string guitar will be used to illustrate the disclosed method as applied to guitars, but the application of the method is not so limited.

Notes on the chromatic scale are represented by a sequence of three colors. The preferred colors are silver, black, and gold, but any three colors may be chosen and used in any order. Generally, the colors should be visually distinct from one another. Moreover, it is advantageous for the colors to be amenable to use on sheet music using standard notations. On an instrument, the selected colors may be used to denote how to correctly play the note, such as coloring the keys on a keyboard or between the frets of a guitar. The strings on an instrument may also be colored for quicker recognition. Because the notes of the chromatic scale are most readily visualized on a keyboard, particular mention of keyboards will be made throughout to enhance understanding of the disclosed method. However, it should be understood that there is no such limitation and the disclosed method and apparatus may be applied to virtually any chromatic instrument.

Because any combination of three colors is encompassed by the present disclosure and attached claims, a generic sequence of three colors and notes proceeding from lower to higher notes (from left to right on a standard keyboard) is represented by the letters X, Y, and Z repeated across the keyboard. The color patterns of various types of chords will be described using these letters and the first note of a chord, which consistent with commonly accepted conventions will always be the lowest note of the chord, will always be represented herein by X although any note across the chromatic scale may, of course, be the first note of a chord. This generic pattern (e.g., X-Y-Y for a Major chord) can be easily shifted to any color first note (i.e., Y-Z-Z or Z-X-X). The key is knowing how the color changes or not from the first note's color as the pattern or sequence progresses.

A brief review of music theory, especially as it relates to different types or classes of chords is useful in understanding how the disclosed method and apparatus improve the teaching and facilitate the learning of music. Each successive note in the chromatic scale (and each successive note on a keyboard) is a half-step away from adjacent notes (or keyboard keys). An interval is the number of half-steps between notes. All chord structures may be described on the basis of “intervals.” Table 1 gives the common names for each interval as defined by the number of half-steps from that note (half steps proceeding from lower to higher tones—i.e., from left to right on a keyboard).

TABLE 1
INTERVALS

| No. of half-steps | Interval name |
|---|---|
| 1 | minor 2^{nd} |
| 2 | Major 2^{nd} |
| 3 | minor 3^{rd} |
| 4 | Major 3^{rd} |
| 5 | Perfect 4^{th} |
| 6 | Tritone |
| 7 | Perfect 5^{th} |
| 8 | minor 6^{th} |
| 9 | Major 6^{th} |
| 10 | minor 7^{th} |
| 11 | Major 7^{th} |
| 12 | Perfect 8^{th} |

A scale consists of eight notes of the chromatic scale beginning and ending on the same note one octave apart. The most common scale, the major scale, consists of a Tonic (i.e., the first note of the scale) followed by the Major 2^{nd}, Major 3^{rd}, Perfect 4^{th}, Tritone (also known as Augmented 4^{th}, diminished 5^{th}, or flattened 5^{th}), Perfect 5^{th}, Major 6^{th}, Major 7^{th}, and Perfect 8^{th} (the Perfect 8^{th} is an one octave interval). For example, the C Major scale consists of C-D-E-F-G-A-B-C. This is the most commonly used and simplest scale because it has no sharps or flats—i.e., no black keys on a piano keyboard. A minor scale consists of a Tonic followed by Major 2^{nd}, minor 3^{rd}, Perfect 4^{th}, Tritone, Perfect 5^{th}, minor 6^{th} (also known as Augmented 5^{th}), minor 7^{th}, and Perfect 8^{th}. The same set of notes may form more than one scale, but with different starting points. For example, the C Major scale is C-D-L-F-G-A-B-C and the A minor scale is A-B-C-D-E-F-G-A. As can be seen here, the minor scale that corresponds to a Major scale will always begin with the sixth note of the Major scale (e.g., the sixth note of C Major scale is A, which is also the first note of the A minor scale).

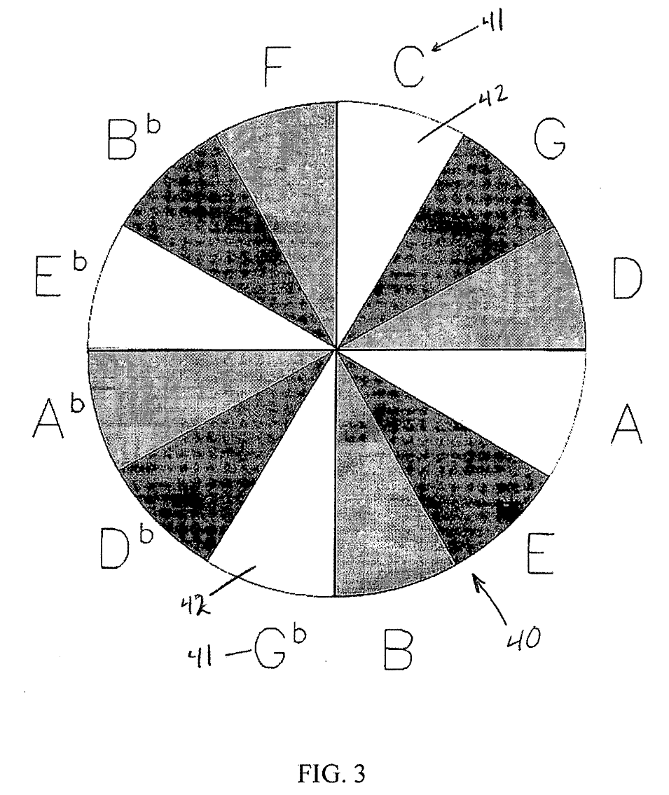

Music is generally said to be in a certain “Key.” That is, it is written using primarily the notes in the scale of the same name (a note that is not part of that Key or scale is referred to as an “accidental”). Thus, C Major Key has no flats or sharps. Keys are often visually represented in what is called the Circle of Fifths, because the names of all the notes in the circle correspond to notes at Perfect 5^{th} intervals moving clockwise (the Circle of Fifths may also be referred to as the Circle of Fourths as the names of the notes in the circle correspond to Perfect 4^{th} intervals moving counterclockwise; for convenience, the term “Circle of Fifths” is used exclusively herein). The Circle of Fifths is most useful because it shows us the most commonly used chord progressions in all of music. FIG. 3 illustrates the Circle of Fifths where each interval on the Circle is colored to match the note as colored elsewhere in the disclosed system, which is why the system works so well. Thus, the disclosed system represents the exact colored sequence on the keyboard clockwise and counterclockwise, up the scale and down, respectively.

The value of the disclosed method and apparatus is most clearly seen in connection with chords. All diminished 7^{th} chords have the exact same four notes each at a minor 3^{rd} interval from the preceding note. Thus, they are discrete and are the most permanent and useful building blocks for a musician. A diminished 7^{th} chord includes any selected first note plus the minor 3^{rd}, Tritone, and Major 6^{th}. Adding a fifth note in the sequence would bring in the Perfect 8^{th}, which is the same as the first note only an octave higher. For example, if we began with C, the rest of the chord would be E^{b}, G^{b}, and A. This pattern of four notes repeats across the musical spectrum. Because the sequence of diminished 7^{th} chords repeats by octave, there are only 3 distinct such chords, with an ambiguous tonal center until the interval of a major third is added. Under the disclosed method and apparatus, the notes of any diminished 7^{th} chord are always the same color and any two notes of the same color are part of the same set that makes up one diminished 7^{th} chord. This pattern forms the basis for the disclosed color pattern of notes. It also illustrates visibly the fact that the minor thirds or diminished chords are in and of themselves the most significant building blocks or tools in music.

A Major chord includes its Root (the note after which it is named), Major 3^{rd}, and Perfect 5^{th}. For example, C Major is C, L, and G. The generic color pattern for any given Major chord will always be X-Y-Y. A minor chord differs from a Major chord only in the second or middle note, which will be the minor 3^{rd} rather than Major 3^{rd}. This yields a generic color pattern of X-X-Y. An augmented chord results from replacing the Perfect 5^{th} with the minor 6^{th}. The resulting generic patterns are X-Y-Z for augmented Major chords and X-X-Z for augmented minor chords.

A dominant 7^{th} chord is the notes of any Major chord plus the minor 7^{th}. Thus, the generic pattern of colors is X-Y-Y-Y. A minor 7^{th} chord is the notes of any minor chord plus the minor 7^{th}. Its generic color pattern is X-X-Y-Y. A major 7^{th} chord is the notes of any Major chord plus the Major 7^{th}. The resulting generic color pattern is X-Y-Y-Z. More complex or larger chords are readily accommodated.

Note that all but two of the described chords, an augmented Major chord and a Major 7^{th} chord, use only two of the three colors in a single phrase or statement. In fact, this reflects the fact that most music uses only two of the three colors nearly all of the time.

The preceding chords, and corresponding patterns, are offered by way of illustration and not as an exhaustive list. Numerous additional chords exist, and may still be devised, and all may be represented and taught in like manner.

Although chord structures are rather easily described, actually recognizing and playing chords is much more difficult. Each note in each set of notes on a page of sheet music must be examined and resort to rote memorization of each chord (and possibly the key in which the music is written) must be utilized to identify each chord in a progression of chords.

The patterns are inherent, but in even on the piano (the instrument on which chords are probably most easily found and played) there is nothing that makes them readily discernable. This problem is even greater with the guitar where chords are simply memorized, but with only great difficulty and investment of time that could be used improving other skills, such as finger picking through or around the Circle, in all keys.

Instruments may be marked with the colors per the disclosed system either permanently or temporarily. For example, a piano with keys in three colors matching the disclosed system may be manufactured. Alternatively, keys may modified with an add-on product. For example, keys may be marked with temporary or permanent colored designs, such as a bass or treble cleft, or with spots of any design. Also, overlays placed on the keys may be marked with the desired colors. The same is true of other instruments, such as colored markers for finger positions on a violin or between frets on a guitar. The color markings may also be supplemented or replaced by tactile markings, such as Braille or other forms identifiable by touch alone.

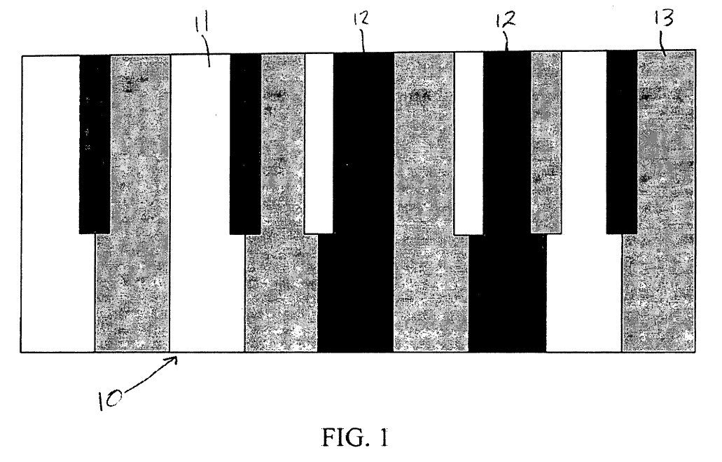

FIG. 1 illustrates one embodiment of the disclosed method applied to a small section of a keyboard 10. There are three types keys 11, 12, 13 each marked in a different way. In the preferred embodiment, the keys 11, 12, 13 are in three colors in a repeating pattern that ignores whether a key 11, 12, 13 would be ivory or ebony on a conventional keyboard. In alternative embodiments, only a portion of a key 11, 12, 13 might be colored. Some embodiments may comprise markings on only a portion of a keyboard 10. The keys or a portion thereof may be colored, or a temporary overlay may be placed on top of a conventional keyboard.

The structure of various chords is discussed above. Keyboard 10 aids in the identification of various chords. For example, the pattern discussed for a Major chord is X-Y-Y, where X, Y, and Z might be keys 11, 12, and 13, respectively. If the chord is C Major (i.e., C-E-G), the C would be a key 11, the E would be a key 12, and G would also be a key 12. Other Major chords are constructed in like fashion. The construction of other types of chords also readily follows from the patterns discussed above.

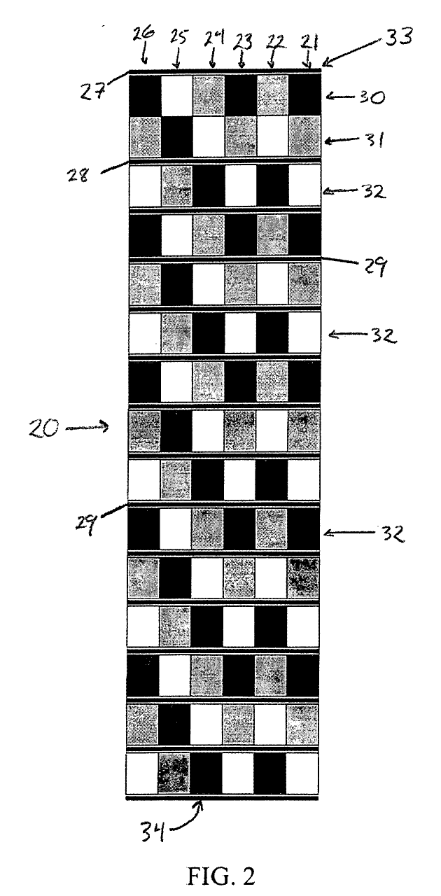

FIG. 2 illustrates another embodiment of the disclosed method applied to fingerboard 30 on the neck of a six-string guitar. The top 33 of FIG. 2 refers to the end of the guitar neck (i.e., where the tuning knobs are located) and the bottom 34 of FIG. 2 refers to the base of the neck. The strings (not shown) would run vertically along each column of markings. The leftmost column 26 of markings corresponds to the bass string (i.e., lowest tuned string) with progressively higher tuned strings proceeding toward rightmost column 21. The columns (and corresponding strings) will be referred to herein by the numbers 26-21, numbered consecutively from left to right in descending order, and tuned to E, A, D, G, B, and E, respectively. Each marking corresponds to the finger position for playing a given note on the overlying string. The location of frets 29 are shown as horizontal lines between markings. There is a fret 29 between each row of markings except for open string row 30 (immediately below open-string “fret” 27) and first fret row 31 (row 31 is the first fret row and references to frets or rows count downward from row 31 and/or fret 27) at the top of FIG. 2. Open string row 30 contains markings that correspond to the open string note. First fret row 31 (immediately above first fret 28) contains markings that correspond to the note played using the first fret (i.e., pressing the string above the first fret). The remaining rows 32, of course, also contain markings that correspond to the note played using that fret. Alternate embodiments may be devised for any string instrument with the correct pattern of colored spots depending on the arrangement and tone of strings, the tuning setting, and the instrument's string configuration. The chord patterns may vary, but patterns will emerge and be apparent to a person of ordinary skill in musical arts and instruction.

With one exception, adjacent strings are a Perfect 4^{th} interval apart, measuring from the higher to lower or lower to higher strings. Thus, the interval up the musical scale from a lower string to an adjacent higher string is a Perfect 4^{th} (e.g., the interval from the sixth string (column 26) to the fifth string (column 25) is a Perfect 4^{th}). These intervals result in the diagonal lines of identical markings across strings 6 to 3 and 2 to 1. The one exception is that the interval from the third string (column 23) to the second string (column 22) is a Major 3^{rd}. This also creates a diagonal, but perpendicular to the others. The interval between first string/column 21 and sixth string/column 26 is two octaves so the markings are identical.

Chords use the same color combinations as described above in this disclosure but some additional explanation of how to identify various chords is given here. As an example, the C Major chord comprises C-E-G. As described above, the generic pattern is X-Y-Y. Using the sixth string (column 26), the fifth string (column 25), and the fourth string (column 24), C Major is played on sixth string, eighth fret; fifth string, seventh fret; and fourth string, fifth fret. This pattern repeats itself up and down the neck of the guitar for any Major chord, and is graphically revealed in this system. The exact same pattern applies to Major chords using the fifth string (column 25), the fourth string (column 24), and the third string (column 23). A Major chord may also include a fourth note that is one octave lower than the highest note (e.g., G-C-E-G for C Major or with the G in the bass, commonly referred to as the first inversion of the chord). This may be done be adding the sixth string (column 26) on the same fret as is played on the fifth string (column 25); sixth string (column 26), third fret; the fifth string (column 25), third fret, the fourth string (column 24), second fret; and third string (column 23), open string for C Major.

Because of the different interval between the third string (column 23) and second string (column), the pattern across fourth, third, and second strings (columns 24, 23, and 22, respectively) is a straight diagonal line—e.g., the fourth string (column 24), tenth fret; the third string (column 23), ninth fret; and second string (column 22), eighth fret for C Major. This pattern repeats itself for different chords up and down the neck on these three strings.

It is a simple matter to convert the Major chord into a minor chord by simply adjusting the middle note one half-step to a lower note, which is the same as moving up one fret. The generic pattern for a minor chord is X-X-Y. Thus, in the case of C Major on the sixth, fifth, and fourth strings (columns 26, 25, and 24, respectively), the middle note (fifth string 25) is played on the sixth fret instead of the seventh fret. Other Major chord patterns are adjusted in like fashion.

The minor 3^{rd} interval (always the same color) between adjacent strings is easy to visualize and find using the disclosed system as it is a mere “stair-step” up to the same color on the next string (from lower to higher tone string). This is important and valuable as minor third intervals are common to many chord structures.

An example of another type of chord is the diminished 7^{th} (X-X-X-X). As described above, a diminished 7^{th} comprises four consecutive notes of the same color. For example, C-Eb-Gb-A, may be played on the sixth through third strings (columns 26 to 23, inclusive, respectively). Two pairs of diagonal adjacent frets are played on the sixth and fifth strings and on the fourth and third strings. For example, this chord may be played on sixth string (column 26), second fret; fifth string (column 25), third fret; fourth string (column 24), first fret; and third string (column 23), second fret. Of course, moving up and down the neck changes only which diminished chord is played.

The notes of a chord may be played sequentially (i.e., not simultaneously) on a singe string in much the same as could be done on a keyboard to play any melody or arpeggio. Using C Major as an example (X-Y-Y), the first note may is followed by a note four frets lower (referring to the orientation of FIG. 2) followed by the third note three frets lower.

This system may be readily adapted to any string instrument whether fretted or unfretted. The position and pattern of markings will vary between instruments based on the arrangement and tuning of strings. For a fretted instrument, the marking may cover all of the space between frets. For an unfretted instrument, the marking preferably is large enough to be readily seen during playing yet small enough to assist the musician in finding the precise fingering position. Such adjustments may be readily made by any person of ordinary skill and knowledge of a given string instrument.

FIG. 3 illustrates how the disclosed method may be applied to the Circle of Fifths 40 (here showing only the Major Keys illustrated by Key indicators 41) to help teach Keys as part of teaching music using the disclosed method. The segment 42 of the Circle 40 associated with each Key 41 is colored the same as the corresponding note, yielding a chart with the three colors repeating in similar fashion to their repetition across the chromatic scale. This also shows the distinct and different color patterns for each tone, and illustrates two and more of the most common chord progressions, the I, IV, I, V, C, F, C, G, the most common used for the blues or rock, as well as the similar ii, V, I, dm, G, C, all appear in different colors and very useful.

Standard musical notation consists of black markings on white papers with different symbols used to indicate note length and systems of lines and spaces used to indicate tone. This system of musical notation may be modified to be compatible with the disclosed system. In the disclosed system, the symbols used to represent the notes are written in colors that correspond to the same notes on an instrument as disclosed above. No other substantive part of standard musical notation need be changed. However, the music should be written on paper of a color that will contrast with all the colors used to indicate the notes. Some instruments, such as but not limited to pianos, guitars, and violins, can be modified so that the key, frets, or finger positions, respectively, are colored to match corresponding notes making it easier for novices to find and play the correct note, facilitating learning, enable or improve improvisation, and reinforcing good playing techniques.

Although the present invention has been described with respect to specific details, it is not intended that such details should be regarded as limitations on the scope of the invention, except as and to the extent that they are included in the accompanying claims.

I claim:

1. A method for teaching music using the chromatic scale, comprising:
associating each note of the chromatic scale with one of three markings wherein every third note is associated with only one of the three markings;
associating each type of chord with patterns of markings.

2. The method of claim 1 wherein the markings comprise three shapes.

3. The method of claim 1 wherein the markings comprise three colors.

4. The method of claim 3 wherein the colors comprise silver, black, and gold.

5. The method of claim 1 wherein the markings comprise three surfaces distinguishable by touch.

6. A standard keyboard comprising:
dividing the keyboard into three sets of keys;
wherein each set of keys consists of every third key;
wherein each set of keys is associated with a marking.

7. The keyboard of claim 6 wherein the markings comprise three shapes.

8. The keyboard of claim 6 wherein the markings comprise three colors.

9. The keyboard of claim 8 wherein the colors comprise silver, black, and gold.

10. The keyboard of claim 6 wherein the markings comprise three surfaces distinguishable by touch.

11. A string instrument comprising a repeating sequence of three markings under a string corresponding to successive finger positions.

12. The string instrument of claim 11 wherein the markings comprise three shapes.

13. The string instrument of claim 11 wherein the markings comprise three colors.

14. The string instrument of claim 13 wherein the colors comprise silver, black, and gold.

15. The string instrument of claim 11 wherein the markings comprise three surfaces distinguishable by touch.

16. A system of music, comprising:
associating each note with one of three colors wherein every third note is the same color;
marking playing positions on instruments to correspond to the color-note associations; and associating chord structures with color patterns.

17. The system of claim 16 wherein the colors comprise silver, black, and gold.

18. The system of claim 16 wherein the instrument is a string instrument, comprising a fingerboard wherein fingering positions are indicated with the color associated with the corresponding note.

19. The system of claim 16 wherein the instrument is a standard keyboard, comprising keys comprising the color associated with the note that is played on a given key.

20. The system of claim 16 wherein each of the colors is also associated with a different one of three surfaces distinguishable by touch.
